(19) United States
(12) Patent Application Publication
(10) Pub. No.: US 2019/0054798 A1
(43) Pub. Date: Feb. 21, 2019

(54) AIR DIFFUSION SYSTEM AND METHOD FOR VEHICLE PASSENGER COMPARTMENT

(71) Applicant: Valeo Systemes Thermiques, Le Mesnil Saint Denis (FR)

(72) Inventor: Moussa Nacer-Bey, Le Mesnil Saint Denis (FR)

(73) Assignee: Valeo Systemes Thermiques, Le Mesnil Saint Denis (FR)

(21) Appl. No.: 16/078,335

(22) PCT Filed: Feb. 2, 2017
(86) PCT No.: PCT/FR2017/050236

§ 371 Date: Aug. 21, 2018

(30) Foreign Application Priority Data
Feb. 22, 2016 (FR) 1600297

(51) Int. Cl. B60H 1/00; B60H 1/34

(52) U.S. Cl. CPC B60H 1/00742; B60H 1/345; B60H 1/00871

(57) ABSTRACT

The invention relates to an air diffusion system and method for a vehicle passenger compartment, comprising at least one aerator (60) and means (50) for orienting said at least one aerator that are suitable for directing a flow of air (62) delivered by said aerator. According to the invention, a device for detecting a face (Vi) of at least one person present in the passenger compartment is connected to said orientation means so as to direct said flow of air towards at least one of the faces detected.

The invention relates to an air diffusion system and method for a vehicle interior. It also relates to an air conditioning system equipped with such a diffusion system and to a vehicle interior equipped with such an air conditioning system. It is particularly intended for the field of automotive vehicles.

Systems for diffusing air into a motor vehicle interior and, more particularly, air diffusion systems intended to cool the passengers of an automotive vehicle provided with an air conditioning system, are known.

Despite the presence of an air conditioning system, creating a pleasant thermal environment inside an automotive vehicle interior in sunny weather or, more generally, in warm weather, is far more difficult than in a large stationary space, for several reasons:
the volume of air in an interior is relatively small and the windows create a greenhouse effect; this greenhouse effect can be overcome by opening the windows and creating draughts, although doing so when an air conditioning system is in operation is somewhat paradoxical,
the internal parts of the interior subjected to light radiation have a tendency to heat up and therefore to contribute to the rising temperature in the interior; and these parts cool down far more slowly,
the passengers may be subjected to widely differing conditions according to the orientation of the vehicle in relation to the sun,
because of the relatively small size of the interior, the ventilation air vents are situated relatively close to the passengers and adjusting the fresh air jet for temperature, direction and intensity all at once is a tricky matter.

EP 1 236 593 discloses a vehicle air conditioning system comprising at least one temperature sensor for measuring the temperature of a surface and an air vent for directing an air flow toward this surface. The flow is oriented, formed into a jet or into a diffuse flow, according to the temperature measured. The surface the temperature of which is measured may be that of a passenger and the system aims to keep this temperature within a certain range of values.

That system suffers from a number of disadvantages: the “surface temperature” of a passenger is difficult to determine and in any event is not always indicative of how comfortable the passenger feels.

The invention proposes a different approach. It is based on the observation that the feeling of comfort in warm weather stems to a large extent from the application of a flow of cool air to the face. Now, the head of a passenger does not lie at a fixed point within an interior, even if only because of the difference in size between individuals. The passenger usually makes his own adjustments to the air vent or vents so as to orient the air flow toward his face. Nevertheless, this is somewhat impractical because once the setting or settings have been obtained, the passenger must no longer move if he wishes to keep the cool air flow on his face.

Accordingly, the invention proposes an air diffusion system for a vehicle interior comprising at least one air vent and orientation means for orienting said at least one air vent, which are capable of directing an air flow delivered by said air vent, characterized in that it further comprises a detection device for detecting a face of at least one individual present in the cabin, connected to said orientation means so as to direct said air flow toward at least the face or faces detected.

The system according to the invention notably but not necessarily falls within the context of an air conditioning system for an automotive vehicle such as a car, truck, bus etc. In the conventional way it comprises air vents for diffusing air-conditioning air or external air, these air vents comprising flaps which are orientable so as to vary the orientation of the air flow they deliver. At the same time or alternatively, they can themselves be mounted on a ball joint and able to pivot about one or two axes. Throughout the text means allowing the flaps of an air vent and/or the air vent in its entirety to be oriented will be referred to as “orientation means”.

The air diffusion air vents are advantageously provided with actuators so as to make them controllable by electric and/or electronic means so that the orientation of the air flow they deliver can be varied without human intervention.

The system is characterized by its ability to:
detect the face of at least one individual present in the interior, referred to further on as a passenger, regardless as to whether or not this individual is driving,
orient at least one air vent in such a way as to direct an air flow toward this face.

This system therefore adapts in real time to the position of the head of the passenger or passengers in order to direct the air flow toward their head.

The temperature of the diffused air and the speed thereof are considered to be determined by the user using conventional means.

Advantageously, the detection device may comprise at least one optical sensor, in particular a sensor able to form an image of a face.

Such an optical sensor is, for example, a camera, a web cam or the like, capable using optics and a sensor positioned behind these optics, of generating an electrical signal indicative of an image. Advantageously, said sensor is fitted with wide-angle optics, so that a single optical sensor can form an image of a relatively large volume.

Advantageously, the detection device may comprise signal processing means for processing the signals delivered by the optical sensor or sensors, said processing means being able to detect one or more faces.

This signal processing device comprises, for example, a first microprocessor associated with a first memory in which there is recorded software able to detect the faces present in an image. The software, from the habitual traits of a face, is able, by shape recognition, to identify a face within an image.

This image processing is followed by the following geometric calculations:
calculating the orientation of this face with respect to the optical sensor from its position in the plane of the image,
calculating the position of the face in the interior; such a calculation entails estimating the distance between the optical sensor and the passenger,
calculating the orientation to be given to each air vent so that the air flow it delivers is directed toward the face.

These calculations are advantageously performed by the signal processing device.

Advantageously, one and the same single optical sensor is used for several, or even all, of the passengers in the interior.

Advantageously, said orientation means are configured to direct the air flow toward the same face from all or some of said air vents. In other words, several air vents may simultaneously direct their air flow toward the head of one passenger. These passengers are notably those occupying the first row of seats, referred to as front seats, including the driver, but not only.

Advantageously, the detection device comprises control means for controlling said orientation means capable of directing, notably to center, at least one air flow toward a face. Said control means use only the signals delivered by the optical sensor or sensors so as to orient the air flow toward a face, the control means being connected to the signal processing means that process the signals delivered by the optical sensor or sensors or, in other words, only the signals delivered by the optical sensor or sensors are taken into account when orienting the air flow toward a face. The air diffusion device according to the invention is thus capable of managing the diffusion of air within the vehicle using a minimal number of components, thus making it easier to install in the vehicle.

These control means comprise for example a second microprocessor associated with a second memory in which there is recorded software capable of controlling the means of orienting the air vent or vents closest to the face detected. Of course, the first and second microprocessors may be combined, as may the first and second memories.

Advantageously, the control means may comprise a time delay, for example set according to the level of speed of movement of the face. A time delay could, for example, be the production of an output signal that is separated from an input signal by a predetermined space of time.

This makes it possible to avoid the air vents tracking a passenger in all his rapid movements.

Advantageously, the control means and the orientation means are also designed to adjust the divergence of the air jet diffused by an air vent.

Aside from orienting the air flow delivered by an air vent, the invention comprises means for determining the divergence of said flow, namely the solid angle in which it is delivered, the orientation of the air flow being considered to be that of the median axis of the solid angle.

Advantageously, the divergence of the jet of an air vent may be determined as a function of the distance between the face and said air vent.

The greater the distance between the air vent and the head of the passenger, the smaller will be the divergence given to the air flow: the further the passenger is away from the air vent, the more concentrated the jet delivered.

Advantageously, the divergence of the jet from an air vent may be determined according to the size of the facial image detected.

In that case, the control means use a measurement of the size of the face detected by the optical sensor; the smaller this size, the more narrow the air jet will be; conversely, if the passenger leans forward, the size of his face will increase and the air jet will be more divergent.

These embodiments do not exclude manual adjustment on the part of the user of the divergence of the air jets, this divergence then being adjusted automatically by the control means according to the position of his head in the interior at any instant.

Advantageously, the air diffusion system may comprise a means for activating and/or deactivating the face detection device.

The user may elect to switch off the automatic face detection device.

The invention also relates to an air conditioning system for a vehicle interior, comprising an air diffusion system as described hereinabove.

The invention also relates to a vehicle interior comprising such an air conditioning system.

Advantageously, the interior comprises at least one row of seats arranged transversely in said interior and the detection system comprises a single optical sensor per row.

When the optical sensor is positioned for example at the dashboard, it may detect the faces of the passengers occupying the first row of seats, notably the driver, and the orientation means govern the air vents associated with this first row, namely those capable of reaching the passengers occupying this row.

By contrast, the faces of the passengers seated in the row or rows situated behind that of the driver risk not being readily visible to this sensor. Other air diffusion air vents are associated with these rows, for example in the pillars between the front door and the rear door, in the arm rests, etc. Therefore, the vehicle advantageously comprises as many optical sensors as it has rows of seats. By contrast, the signal processing means, the calculation means and the control means are advantageously shared resources. Since one optical sensor is associated with one row of seats, that determines a mean distance between the sensor and the passengers which distance is used in calculating the position of the face.

The invention also relates to an air diffusion method for a vehicle interior comprising at least one air vent, orientation means for orienting said at least one air vent so as to direct an air flow delivered by this air vent and a detection device for detecting a face of at least one individual, notably at least one optical sensor, characterized in that it comprises the following steps:
detecting at least one face in the image delivered using said detection device, notably by the at least one optical sensor,
activating the orientation means that orient said at least one air vent so as to direct the air flow toward said at least one face.

Advantageously, the method comprises the following steps:
capturing an image of the interior using the at least one optical sensor,
processing the signals delivered by said sensor so as to detect at least one face,
calculating the position of said face within the image,
calculating the position of said face within the interior,
assigning at least one air vent to each face,
calculating the orientation to be given to each air vent so that the air jet it delivers reaches a face,
orienting at least one air vent so as to direct its air jet from said air vent toward said face.

Advantageously, the method may comprise the following step:

if just one face is detected, assigning all the air vents to this face.

The method may also comprise a step in which the passenger activates or deactivates:

the automatic orientation function

the orientation of all the air vents.

Embodiments and alternative forms will be described hereinafter by way of nonlimiting examples with reference to the attached drawings in which:

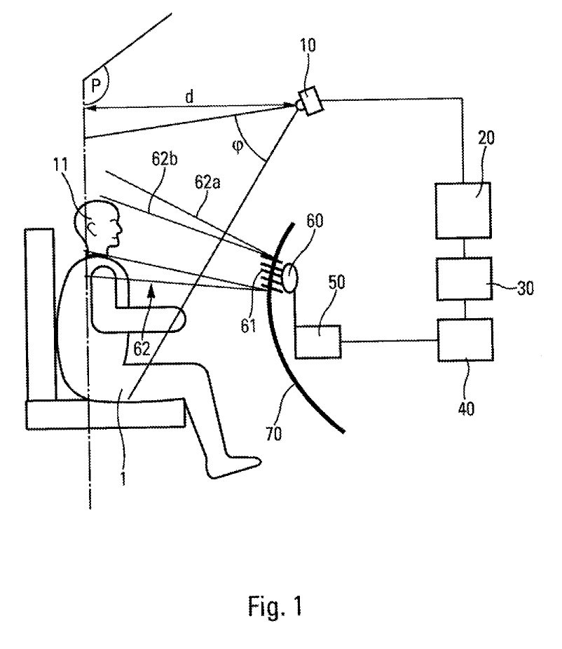

FIG. 1 is a block diagram of an air diffusion system according to the invention,

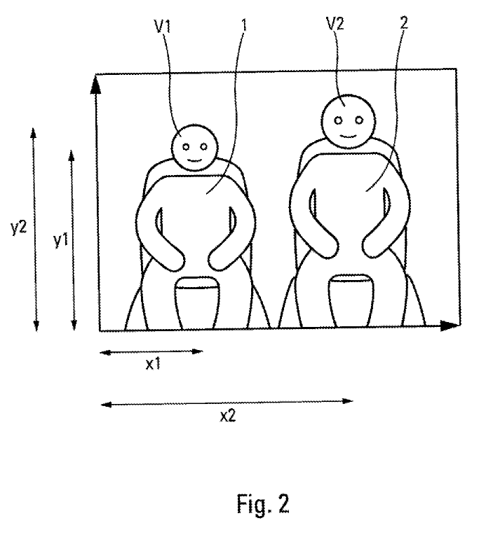

FIG. 2 depicts an image captured by an optical sensor in the case of two passengers,

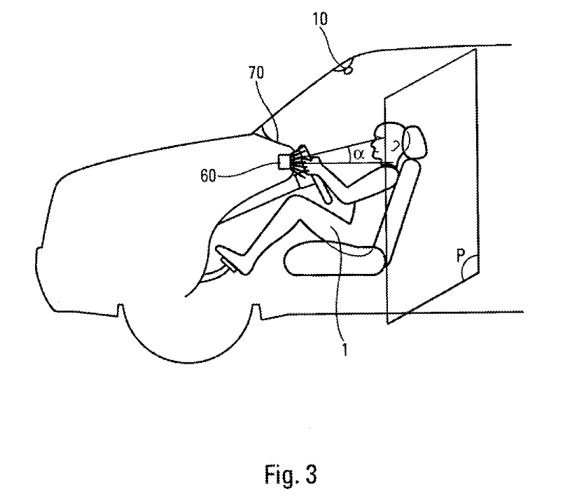

FIG. 3 depicts an elevation view of a driver or passenger,

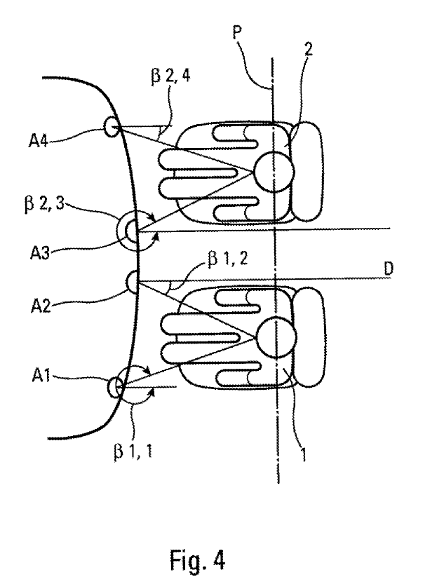

FIG. 4 depicts a plan view of a driver and of a passenger,

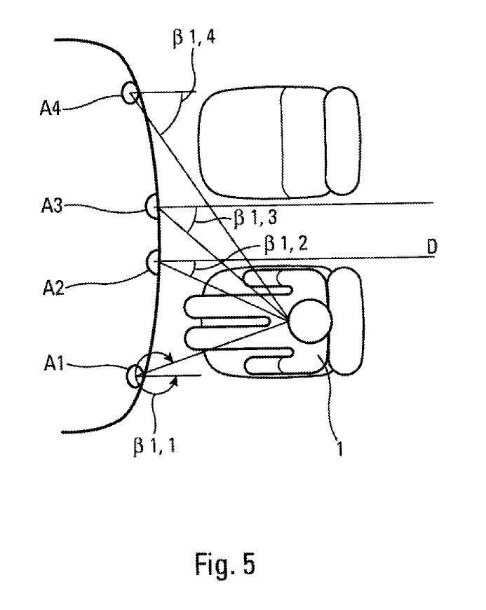

FIG. 5 depicts a plan view of a driver alone.

As illustrated in FIG. 1, the air diffusion system according to the invention comprises a detection device, particularly an optical sensor 10, for example a camera, in this instance positioned above the windshield in a vehicle interior, observing a scene with an image capture angle φ. The optical sensor is connected to a signal processing device 20 which receives the image captured by the optical sensor. The signal processing device 20 comprises software recorded in a memory and which is able to run in a microprocessor so as to extract from this image, in the known way, one or more faces from an image using the characteristic traits of a face. At the end of this processing the coordinates (xᵢ, yᵢ) of the center of a face Vᵢ in the plane of the image are obtained.

FIG. 2 illustrates an image captured by the one same optical sensor, in which image it is possible to discern two passengers 1, 2 and therefore two faces V₁, V₂. The face V₁ of the first passenger 1 has the coordinates (x₁, y₁) in this image, those of the face V₂ of the second passenger 2 being (x₂, y₂). Said sensor here forms an image of all of the passengers but such a vertical angle is unnecessary, simply forming an image from the seating part of the seats upwards or even from a certain height above the seating part of the seats of the interior potentially being enough.

The coordinates (xᵢ, yᵢ) are transmitted to a calculation means 30 capable of converting them into coordinates (Xᵢ, Yᵢ) of this face Vᵢ in the plane P in which the passenger 1 whose face has been detected is located. The calculation means for that uses the position of the optical sensor 10 and the distance d between this sensor and the plane P, which are known by construction and/or deduced by correlation with respect to the position of the seats. The plane P is slightly forward of that of the backrest of the row of seats in which the passenger is seated, for example by the order of 20 cm.

The position of the plane P is illustrated in particular, schematically, in FIG. 3.

The coordinates (Xᵢ, Yᵢ) are transmitted to a calculation means 30 which calculates the orientations (α_{i,j}, β_{i,j}) to be given to the various air vents Aⱼ capable of reaching the head the face Vᵢ of which has been detected. These orientations are defined with respect to a horizontal plane and to a vertical plane:
let α_{i,j} be the angle of orientation to be given in the vertical plane to the air vent Aⱼ so that its air jet reaches the face Vᵢ,
let β_{i,j} be the angle of orientation to be given in the horizontal plane, measured in the clockwise direction, to the air vent Aⱼ so that its air jet reaches the face Vᵢ.

For that, the calculation means 30 begins by assigning each air vent Aⱼ to a face Vᵢ. This assignation is done naturally insofar as the vehicle interiors very generally exhibit symmetry about a vertical median plane. Thus all the air vents on one side of this plane of symmetry are assigned to the passenger seated on the same side of this plane.

FIG. 4 illustrates this situation: the air vents A₁ and A₂ situated to the left of the median plane of symmetry considered in the direction of travel are assigned to the passenger 1 on the left of this plane, and the air vents A₃ and A₄ situated on the right are assigned to the passenger 2 to the right of this plane. With respect to a longitudinal direction D of the vehicle, the air jets of the air vents A₁ to A₄ are therefore oriented as follows in the horizontal plane:
air vent A₁, angle β_{1,1}, toward the first passenger 1,
air vent A₂, angle β_{1,2}, toward the first passenger 1,
air vent A₃, angle β_{2,3}, toward the second passenger 2,
air vent A₄, angle β_{2,4}, toward the second passenger 2.

Of course the same is true of the angles α_{i,j} in the vertical plane.

As illustrated in FIG. 5, an exception occurs when just one face is detected, for example when the driver is on his own; another example being that when, with the vehicle stopped, the non-driving passenger is alone in the interior. In that case, advantageously, the calculation means assigns all of the air vents to the sole face detected. In the case of a driver on his own, this may lead to a drop in the level of air conditioning, and therefore to energy savings. In this instance, the air vents A₃ and A₄ situated to the right of the median plane of symmetry are this time assigned to the sole passenger 1. In this case, the angles of orientation become respectively β_{1,1}, β_{1,2}, β_{1,3} and β_{1,4}.

Nevertheless, the passenger may find having all the air vents assigned to his face in this way somewhat unpleasant; the system advantageously comprises a means for activating and/or deactivating this function of assigning all the air vents to the one same passenger. In that case, the unassigned air vents A₃, A₄ are either deactivated or their jet is directed axially into the interior.

In instances in which the system does not manage to detect any face (for example if there is a large hat present), it arranges the jet from the air vents for example along the longitudinal direction D of the vehicle.

Referring once again to FIG. 1, it may be seen that the diffusion system according to the invention further comprises one or more air vents 60, for example placed on the dashboard 70 of the vehicle, and means of orienting said air vent or vents 60, for example one or more actuators 50. Said system also here comprises control means 40, controlling said actuators 50.

According to the invention, said detection device is connected to said orientation means. More specifically here, the control means 40 are configured to be governed by the calculation means 30.

The orientations (α_{i,j}, β_{i,j}) are transmitted to said control means 40 so as to orient flaps 61 of the air vent and/or the air vent itself. The air vent thus delivers an air jet 62 directed toward the head 11 of the passenger.

Advantageously, the air vent 60 may deliver an air jet 62 that is more or less divergent: the air jet 62a is more divergent than the air jet 62b more specifically targeting the head 11 of the passenger 1. This divergence may be the result of a calculation performed by the calculation means 30 and based on the distance between the air vent and the head of the passenger, alternatively on the size of the head of the passenger, as calculated by the signal processing device 20.

1. An air diffusion system for a vehicle interior comprising:
at least one air vent;
orientation means for orienting said at least one air vent, which are capable of directing an air flow delivered by said air vent; and
a detection device for detecting a face of at least one individual present in the cabin, connected to said orientation means so as to direct said air flow toward at least the face or faces detected.

2. The air diffusion system for a vehicle interior as claimed in claim 1, wherein the detection device comprises at least one optical sensor, able to form an image of a face.

3. The air diffusion system as claimed in claim 2, wherein the detection device comprises signal processing means for processing the signals delivered by the optical sensor or sensors, said processing means being able to detect one or more faces.

4. The air diffusion system as claimed in claim 1, wherein the detection device comprises control means for controlling said orientation means capable of directing at least one air flow toward a face.

5. The air diffusion system as claimed in claim 4, wherein the control means comprise a time delay.

6. The air diffusion system as claimed in claim 4, wherein the control means and the orientation means are also designed to adjust the divergence of the air jet diffused by an air vent.

7. The air diffusion system as claimed in claim 6, wherein the divergence of the jet of an air vent is determined as a function of the distance between the face and said air vent and/or as a function of the size of the facial image detected.

8. The air diffusion system as claimed in claim 1, wherein said orientation means are configured to direct the air flow toward the same face from all or some of said air vents.

9. The air diffusion system as claimed in claim 1, further comprising a means for activating and/or deactivating the face detection device.

10. An air conditioning system for a vehicle interior, comprising an air diffusion system as claimed in claim 1.

11. A vehicle interior comprising an air conditioning system as claimed in claim 10.

12. The vehicle interior as claimed in claim 11, said interior comprising at least one row of seats arranged transversely in said interior, wherein the detection system comprises a single optical sensor per row.

13. An air diffusion method for a vehicle interior comprising at least one air vent, orientation means for orienting said at least one air vent so as to direct an air flow delivered by this air vent and a detection device for detecting a face of at least one individual, the method comprising:
detecting at least one face using said detection device; and
activating the orientation means that orient said at least one air vent so as to direct the air flow toward said at least one face.

14. The air diffusion method as claimed in claim 13, wherein said detection device comprises at least one optical sensor, said method further comprising:
capturing an image of the interior using the at least one optical sensor;
processing the signals delivered by said sensor so as to detect at least one face;
calculating the position of said face within the image;
calculating the position of said face within the interior;
assigning at least one air vent to each face;
calculating the orientation to be given to each air vent so that the air jet it delivers reaches a face; and
orienting at least one air vent so as to direct its air jet from said air vent toward said face.

15. The air diffusion method as claimed in claim 13, the method further comprising:
if just one face is detected, assigning all the air vents to this face.
